(19) United States
(12) Patent Application Publication
(10) Pub. No.: US 2020/0134637 A1
(43) Pub. Date: Apr. 30, 2020

(54) SYSTEMS AND METHODS FOR PRE-FILLING AND/OR PREDICTING RESPONSE DATA BY USE OF ARTIFICIAL INTELLIGENCE (AI) IN ON-LINE TARGETED SURVEYS TO CUSTOMERS TO IMPROVE THE COLLECTED SURVEY RESPONSE DATA

(71) Applicant: salesforce.com, inc., San Francisco, CA (US)

(72) Inventor: Karthick Srinivasan, Hyderabad (IN)

(21) Appl. No.: 16/177,051

(22) Filed: Oct. 31, 2018

(51) Int. Cl. G06Q 30/00; G06F 17/24

(52) U.S. Cl. CPC G06Q 30/016; G06F 17/243

(57) ABSTRACT

A system and method for embedding response data to an on-line survey when soliciting feedback through the use of an on-line survey to user about an user experience to a software application service including: sending the on-line survey with response data included to aid the user in completing the on-line survey; embedding with response data pre-filled or predicted responses to at least one or more questions in the on-line survey by using an artificial intelligence (AI) model based on historical response data to on-line surveys and the response data predicted by algorithmic solutions from a set of data points and machine data designated within the software application service; and response time of providers to resolve the user requests during the software application service; and enabling the user to selectively agree or disagree with embedded pre-filled or predicted response data.

### TECHNICAL FIELD

Embodiments of the subject matter described herein relate generally to pre-populating or predicting response data by a customer or end-user in a targeted survey. More particularly, embodiments of the subject matter relate to the automatic execution of processes to analyze data points in the course of a service request for a targeted survey to pre-populate the survey with predictive response data thereby increasing the response rate and effectivity of the survey results.

### BACKGROUND

With the growing use of conducting on-line surveys for gauging customer satisfaction and service enable a quick and efficient way of collecting information from any number of target customer populations. However, simultaneously, customer populations are recurrently asked to complete targeted surveys on-line potentially leading to survey fatigue. One of the most frequently reported effects of over-surveying is a decrease in overall response rates. This situation has significant impact on the generalizability and external validity of findings based on on-line surveys. The collection of reliable data is, nevertheless, crucial for analytics and strategies needing solutions for achieving acceptable response rates.

The emergence of predictive analytics that have been used to optimize business processes by applying machine learning (ML) and artificial intelligence (AI) algorithms to uncover new statistical patterns in order to learn from past behaviors about how to do a certain business process better and deliver new insights into the business processes present opportunities in meeting the goal of higher response rates in targeted on-line surveys. However, decisions made by the use of these data analytic methods are only as good as the data on which the solutions are based. Hence, the collection of the data remains of paramount importance and must adhere to specific standards and quality to meet accuracy requirements of on-line survey response data collection. Further, the survey quality data indicators can be assessed by the survey response rate where a survey is deemed more likely a better assessment when producing a higher response rate. Hence, improvements in survey response rates for on-line surveys have the added benefit of improving the quality of the collected response data.

Therefore, it is desired an on-line survey system that uses artificial intelligence application based on relevant data collected to improve response rates as well as aiding a customer or end user in the completion of the on-line survey for better response data collection and more accurate survey data of support in resolving requests for customer service application in an enterprise network.

Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram for an on-line survey system with pre-filled and predictive response data applications, in accordance with the disclosed embodiments;

FIG. 2 is a screenshot of an email invite to an on-line survey with an embedded question, in accordance with the disclosed embodiments;

FIG. 3 is a diagram for an on-line survey system with pre-filled and predictive response data applications, in accordance with the disclosed embodiments;

FIGS. 4A and 4B are flow charts that illustrates an embodiment of a process for initiating a case investigation, acknowledging the case, and checking of additional information for an on-line survey system with pre-filled and predictive response data, in accordance with the disclosed embodiments; and

FIG. 5 is a flowchart illustrating an administrative set-up for the on-line survey system in accordance with the disclosed embodiments;

FIG. 6 is a flowchart illustrating a run-time of the on-line survey system in accordance with the disclosed embodiments; and

FIG. 7 is a conceptual block diagram of a multi-tenant system in accordance with one embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to systems and methods for prefilling or predicting on-line responses for a targeted customer making responses to events associated with fulfilling a service request. More specifically, the subject matter relates to the execution of action items corresponding to a service request placed by the customer based on a service agreement by a vendor. Contemplated herein are techniques for creating and using an artificial intelligence (AI) models, pre-filling of response data and historical data to ease the completion of response data in the targeted on-line survey.

Some embodiments of the present disclosure provide a method and system for pre-filling or predicting response data in target on-line surveys to targeted end-users or customers soliciting feedback of service support provide to resolving requests about a software application service.

Some embodiments of the present disclosure provide a method and system for pre-filling or predicting response data in target on-line surveys to targeted end-users or customers aid in the completion of targeted on-line surveys, to reduce survey fatigue experienced by the end-user or customer, to collect more accurate data of a customer support experience and to improve response rates and accuracy results of the response during and after the completion by the end-user or customer of the on-line surveys.

Some embodiments of the present disclosure provide a method and system for pre-filling or predicting response data in target on-line surveys to targeted end-users or customers provide checking tools for determining whether response data collected is within a norm or out of a norm, to change the response and to give the end-user an opportunity in the on-line survey process to agree, disagree or change the response data in the targeted on-line survey.

Some embodiments of the present disclosure provide a method and system for pre-filling or predicting response data in target on-line surveys to targeted end-users or customers using network connected enterprise artificial intelligence application with prediction builder application to predict responses to questions in the targeted on-line surveys, to determine in advance or during a completing of an-online survey, a customer or end-user customer satisfaction (CSAT) score for determining a level of customer satisfaction for a support service in response to a customer or end-user request about a enterprise network service application.

Certain terminologies are used with regard to the various embodiments of the present disclosure. The service effectiveness pertains to use cases, investigations or service requests of an effectiveness of aftermarket services that vendors may provide to customers. The cases, investigations and/or service requests are resolved and closed and then a survey is provided to the end customer or user in order to collect data to understand the customer or end user's level of satisfaction of the service provided and to evaluate parts of or the overall service itself effectiveness. The market analysis pertains to when surveys are sent out to a wide set of audience, users, customers to gain further comprehension if a market space warrants a particular type of product/service or to gain insight into the nature of a particular product/service use.

The data collection pertains to a variety of surveys including on-line surveys, targeted surveys etc. that are intended to collect only data directly from users, customers and other entities. The data points pertains to points of data that an user enters or event driven data; For example, such data points include user entered comments or feed, turn-around times exacted for case acknowledgements etc. which, in certain instances, can be analyzed by AI computer applications or machine learning (ML) modeling to analyze the data around the data points to pre-populate the survey with a predictive response. This automated data processing of entering in data can lessen the amount of data the customer is required to entered without compromising the sufficiency of data or range of data in a needed data sample or set. In addition, other benefits that are derived may include an overall potential increase in the response rate to the on-line survey. Further, in such instances, the pre-populating of the response data occurs methodically and not in happenstance that lends to a more intelligent intake of data rather than use of default data resulting in a beneficial increase of confidence levels of the end user or end customer of the response data generated.

In various exemplary embodiments, a request, investigation or case can be considered a record of a statement that an action responsive to a customer service issue has been performed at a past point in time or is currently being performed at the present time in accordance with a service agreement by the vendor to the customer.

In some exemplary embodiments, the customer or end-user request can be placed on a distributed ledger of a blockchain by an entity (e.g., person, organization, business) associated with an assertor type blockchain node. Any blockchain node of the network of blockchain nodes may be an “assertor” blockchain node. When referring to a particular assertion, the assertor blockchain node is the node that has placed the particular assertion on the distributed ledger of the blockchain. In such a record generation, a consensus can be considered the service agreement between a predefined, minimum quantity of nodes of the blockchain network, that the record is valid. The service agreement may include an affirmative assent that the assertion is valid, by each customer, end user associated with one of the minimum quantity of nodes. The record must be asserted with a time required for agreement to be reached. Each customer or end user node provides assent according to its own choice and timeline. Thus, consensus (i.e., agreement between the minimum number of the blockchain nodes) may or may not be reached, and if reached, may require any period of time.

The survey response data collected by targeted surveys after a customer completes a particular business action has been deemed a reliable means of generating and obtaining quality data of a customer service experience. This is particularly because of the prevalent use of mobile devices such as smartphones, which allows greater access to on-line surveys as well as the ability to electronically target particular customer populations immediately after the completion of request in an enterprise service platform to gauge the customer service experience. However, there are drawbacks to on-line survey data collections particularly in the case when the responses are entered via mobile devices. That is, the response rate may be reduced because the customer can become distracted (i.e. because it is easy to multi-task while using a mobile device) and windowing of through the questionnaires of a survey may require clicking through multiple screens on a mobile display. Due to these plethora of obstacles, the values and quality of the response data and the overall effectiveness of the targeted survey can be reduced.

It is desirable to provide improvements to the operation of filling out responses to an on-line targeted survey to assess and improve timings of particular events in the response pipeline and provide additional knowledge when providing responses to various customer service requests and conducting investigations in accordance with customer service agreements.

In addition, it is desirable to use pre-filled response data (alleviating necessitated customer input) as well as predictive response data in each target survey response results to aid the customer in responding to on-line questionnaires, to improve the response rate to questions of the questionnaire in the on-line surveys, to conform and realize customer expectations with a customer support plan implemented in a service contract with the customer and to analyze the customer feedback data along with the other data generated

The described subject matter can be implemented in the context of any computer-implemented system, such as a software-based system, a database system, a multi-tenant environment, or the like. Moreover, the described subject matter can be implemented in connection with two or more separate and distinct computer-implemented systems that cooperate and communicate with one another. The subject matter may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

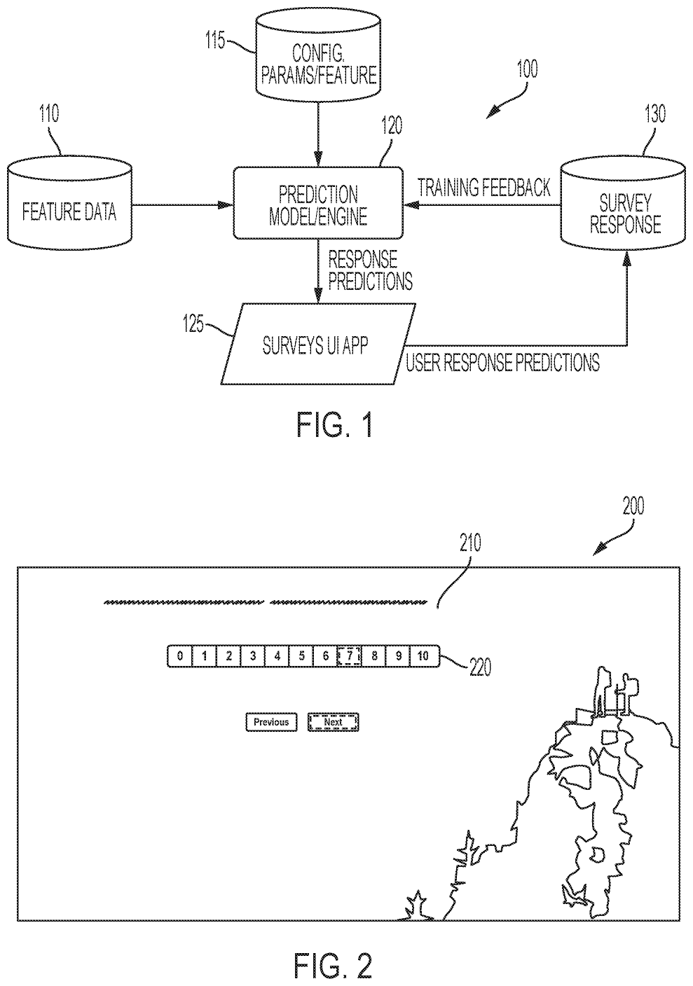

Turning now to the figures, FIG. 1 is a diagram of a system 100 for pre-filling and predicting response data in on-line targeted surveys to events related to customer requests, in accordance with the disclosed embodiments. It should be appreciated that FIG. 1 depicts a simplified embodiment of the system 100 for prediction and pre-filling processes and configurations of the system 100, and that some implementations of the system 100 may include additional elements or components.

The feature database 110 may be configured as a de-centralized, shared, and continuously reconciled set of data for events associated with a customer service request, a case or an investigation. The feature database 110 may be part of a blockchain network (not shown) and use a distributed ledger (DL), which is a database that is shared and synchronized across a network of blockchain nodes which may be disparately located throughout various locations. By distributing and storing data across the network of blockchain nodes the blockchain eliminates risks associated with centrally stored data and centralized points of vulnerability. Moreover, by storing blocks of the feature information that are identical across the network of blockchain nodes the blockchain cannot be controlled by any single entity, and has no single point of failure.

The system 100 shown in FIG. 1 (e.g., the configuration parameters/features 115, the prediction model/engine 120 (i.e. an AI modeling computer) can be implemented using any computer or processor-based computing device that includes at least one processor, some form of memory hardware, and communication hardware to transmit and receive data transmissions. In various exemplary embodiments, the prediction model/engine can be configured with the SALESFORCE® EINSTEIN™ application which is an artificial intelligence prediction app that delivers predictions based on customer enterprise processes and customer data. For example, the SALESFORCE® EINSTEIN™ Prediction Builder (EBP) engine part of the SALESFORCE® EINSTEIN™ application can be used for predicting the survey responses.

For purposes of performing general prediction operations and using the feature data of the feature database 110, the prediction model/engine 120 communicates to receive data from the survey response module 130 and responds with predictive responses to the user interface (UI) of the on-line survey app 125 based on a data set of the feature database 110 (ex. prediction historical data) and the configuration parameters/features 115 via wired and/or wireless communication connections, such as a data communication network.

The data communication network may be any digital or other communications network capable of transmitting messages or data between devices, systems, or components. In certain embodiments, the data communication network includes a packet switched network that facilitates packet-based data communication, addressing, and data routing. The packet switched network could be, for example, a wide area network, the Internet, or the like. In various embodiments, the data communication network includes any number of public or private data connections, links or network connections supporting any number of communications protocols. The data communication network may include the Internet, for example, or any other network based upon TCP/IP or other conventional protocols. In various embodiments, the data communication network could also incorporate a wireless and/or wired telephone network, such as a cellular communications network for communicating with mobile phones, personal digital assistants, and/or the like. The data communication network may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

The prediction model/engine 120 functions to predict response data of customer requests by receiving training feedback from survey response module 130, feature data of the feature database 110 and configuration parameters/features 115 to predict response predictions to the send to the on-line survey app 125. The feature data of the feature database 110 may include on-line survey features such as survey logic, export data and more question types like multiple choice radio buttons, drop downs, rating scales, etc. The feature data of the feature database 110 can list features that are linked to user satisfaction for using a particular software application service. These can include features directed to service within a norm and service outside a norm. For example, such features may be directed to price, ease of service, reliability of service etc. The prediction model/engine 120 functions to create and update an AI model for the on-line responses of the targeted surveys using historical data stored in a repository of survey response module 130.

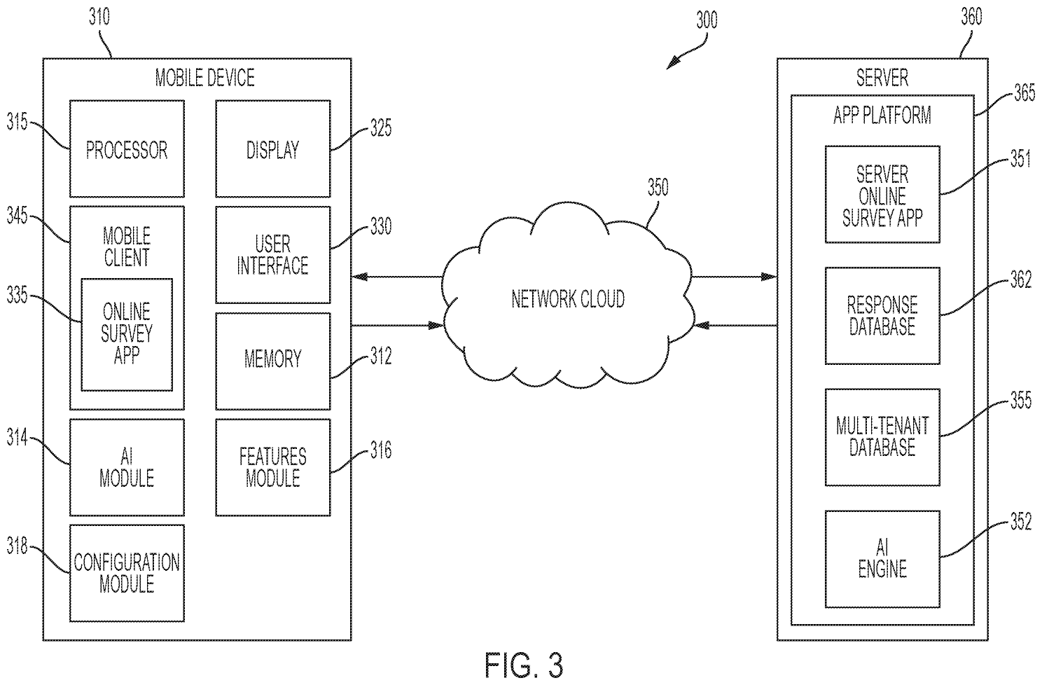

FIG. 2 is a screenshot 200 of a data collection method for an on-line survey in accordance with the disclosed embodiments. The screenshot 200 shows a method where the user simply responds to an embedded question 210 requesting a scaled response 220 using a scale of “0” of (not at all likely) to “10” of (Extremely likely). By the user clicking one of the answer options. The Condition 1, the screenshot 200 started with a short message requesting participation in rating a customer service experience and immediately following the message, the first question was also presented in the email. The question asked “Rate our customer performance for your case entitled “Unable to activate flows in my org”. By using a scale of 0 (Not at all likely) to 10 (Extremely likely), response data is collected. The question is may also be referred to as a Net Promoter Score (NPS). By clicking on one of the answer options, respondents would be directed to the survey webpage, with the answer to the NPS questions registered already. Respondents in the embedded condition were much more likely to click on the embedded question and start the survey than the respondents in the standard condition to click on the “Begin survey” button.

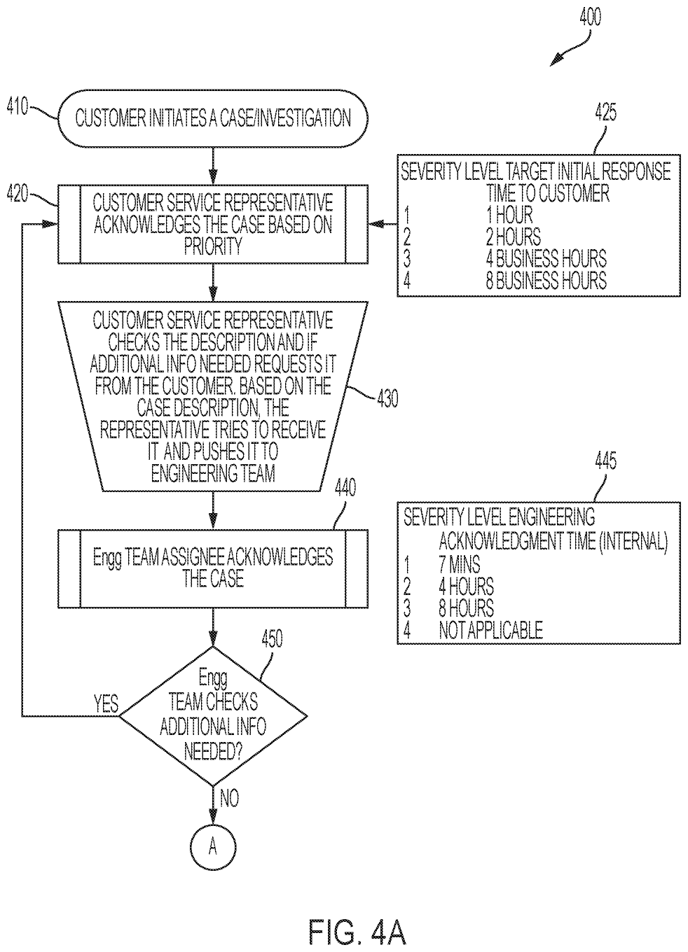

FIG. 3 is an exemplary diagram illustrating a computing platform using an on-line survey app of app client and server system to configure an on-line survey system 300 in accordance in accordance with an embodiment. In conjunction with the configuration illustrated in FIG. 1, in FIG. 3 the customer by the mobile device 310 having a processor 315 and a display device 325 may receive an on-line survey via a client platform in an email to a mobile client 345 to access an on-line survey app 335 connected to a response database 362 of historical response data (incl. data of data points of actions, events in the service support) and fill-out responses to the on-line survey using a mobile user interface (UI) 330. The mobile device 310 is connected to a server 360 via a network cloud 350. The mobile device 310 may include, but is not limited to, a personal computing device such as smartphone or the like but may include such devices as a desktop or laptop computer, a PDA or tablet computing device, a mobile communications device or any other electronic device suitable for use in connection with certain embodiments of the disclosed technology.

It should be noted that the mobile device 310 can be implemented with the on-line survey system 300 depicted in FIG. 1. In this regard, the mobile device 310 shows certain elements and components of the on-line survey system 100 in more detail. The mobile device 310 generally includes, stores, maintains, operates, and/or executes, without limitation: at least one processor 315; a system memory 312 element; a user interface 330; an on-line survey app 335; an artificial intelligence (AI) modeling module 314; a feature module 352, and a configuration module 337. These elements and features of the on-line survey system 300 may be operatively associated with one another, coupled to one another, or otherwise configured to cooperate with one another as needed to support the desired functionality, as described herein. For ease of illustration and clarity, the various physical, electrical, and logical couplings and interconnections for these elements and features are not depicted in FIG. 3. Moreover, it should be appreciated that embodiments of the on-line survey system 300 will include other elements, modules, and features that cooperate to support the desired functionality. For simplicity, FIG. 3 only depicts certain elements that relate to the techniques described in more detail below.

The at least one processor 305 of the mobile device 310 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 305 may be realized as one or more microprocessors, controllers, microcontrollers, or state machines. Moreover, the at least one processor 305 may be implemented as a combination of computing devices, e.g., a combination of digital signal processors and microprocessors, a plurality of microprocessors, one or more microprocessors in conjunction with a digital signal processor core, or any other such configuration.

The at least one processor 305 is communicatively coupled to, and communicates with, the system memory 312 element. The system memory 304 element is configured to store any obtained or generated data associated with a distributed ledger (DL), blockchain functionality, computational capabilities associated with an index value indicating a probability of achieving consensus for a particular assertion, and the initiation of action items, tasks, or processes associated with an assertion. The system memory 304 may be realized using any number of devices, components, or modules, as appropriate to the embodiment. Moreover, the on-line survey system 300 could include system memory 312 integrated therein and/or a system memory 312 operatively coupled thereto, as appropriate to the particular embodiment. In practice, the system memory 312 could be realized as RAM memory, flash memory, EPROM memory, EEPROM memory, registers, a hard disk, a removable disk, or any other form of storage medium known in the art. In certain embodiments, the system memory 312 includes a hard disk, which may also be used to support functions of on-line survey system 300. The system memory 312 can be coupled to the at least one processor 315 such that the at least one processor 315 can read information from, and write information to, the system memory 312. In the alternative, the system memory 304 may be integral to the at least one processor 302. As an example, the at least one processor 315 and the system memory 312 may reside in a suitably designed application-specific integrated circuit (ASIC).

The user interface 330 may include or cooperate with various features to allow a user to interact with the on-line survey system 300. Accordingly, the user interface 306 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the process on-line survey system 300.

In certain embodiments, the user interface 330 may include or cooperate with various features to allow a user to interact with the on-line survey system 300 via graphical elements rendered on a display element. Accordingly, the user interface 330 may initiate the creation, maintenance, and presentation of a graphical user interface (GUI). In certain embodiments, the display device 325 implements touch-sensitive technology for purposes of interacting with the GUI. Thus, a user can manipulate the GUI by moving a cursor symbol rendered on the display of the mobile device 310, or by physically interacting with the display device 325 itself for recognition and interpretation, via the user interface 330.

The AI modeling module 314 creates, updates, and augments an AI model for the blockchain, including modeling the network of blockchain nodes or any subset of the network of blockchain nodes. The AI modeling module 314 creates the AI model using data stored historical data, feature data, and configuration data. The created AI model may be updated (by the AI modeling module 314) according to a timed interval schedule or when triggered by an event (e.g., when a customer request is sent). In some embodiments, the AI modeling module 314 augments the AI model using third party data comprising any related data associated with the customer request.

The network cloud 350 allows access to communication protocols and application programming interfaces that enable real-time video streaming and capture at remote servers over connections. The wireless networks for communicating via the network cloud by the mobile device 310 may use a cellular-based communication infrastructure that includes cellular protocols such as code division multiple access (CDMA), time division multiple access (TDMA), global system for mobile communication (GSM), general packet radio service (GPRS), wide band code division multiple access (WCDMA) and similar others. Additionally, wired networks include communication channels such as the IEEE 802.11 standard better known as Wi-Fi®, the IEEE 802.16 standard better known as WiMAX®, and the IEEE 802.15.1 better known as BLUETOOTH®.

The mobile device 310 includes the mobile client 345 which may use a mobile software development kit “SDK” platform. This SDK platform can provide one step activation of an on-demand services via the on-line survey app 335 such as shown here. The mobile device 310 may include any mobile or connected computing device including “wearable mobile devices” having an operating system capable of running mobile apps individually or in conjunction with other mobile or connected devices. Examples of “wearable mobile devices” include GOOGLE® GLASS™ and ANDROID® watches. Typically, the device will have capabilities such as a display screen, a microphone, speakers and may have associated keyboard functionalities or even a touchscreen providing a virtual keyboard as well as buttons or icons on a display screen. Many such devices can connect to the internet and interconnect with other devices via Wi-Fi, Bluetooth or other near field communication (NFC) protocols.

The mobile client 345 may additionally include other in-apps or apps like the on-line survey app 335 as well as SDK app platform tools and further can be configurable to enable downloading and updating of the SDK app platform tools. In addition, the mobile client 345 uses an SDK platform which may be configurable for a multitude of mobile operating systems including ANDROID®, APPLE® iOS, GOOGLE® ANDROID®, Research in Motion's BLACKBERRY OS, NOKIA's SYMBIAN, HEWLET_PACKARD®'s WEBOS (formerly PALM® OS) and MICROSOFT®'s WINDOWS Phone OS

The on-line survey app 335 or for that matter an in-app of the mobile client 345 provided on the SDK platform can be found and downloaded by communicating with an on-line application market platform for apps and apps which is configured for the identifying, downloading and distribution of apps which are prebuilt. One such example is the SALESFORCE APPEXCHANGE® which is an on-line application market platform for apps and apps where the downloading, and installing of the pre-built apps and components such as an on-line survey app 335 for the mobile client 345 with various pre-fill or predictive data response features.

In addition, these on-line application market platforms include “snap-in” agents for incorporation in the pre-built apps that are made available. The on-line survey app 335 may be configured as a “snap-in” agent where the snap-in agent is considered by the name to be a complete SDK packages that allows for “easy to drop” enablement in the mobile client 345 or into webpages.

The server 360 acts as a host and includes the server on-line survey app 351 that is configured for access by an application platform 365. The application platform 365 can be configured as a platform as a service (“PaaS) that provides a host of features to develop, test, deploy, host and maintain applications in the same integrated development environment of the application platform. Additionally, the application platform 365 may be part of a multi-tenant architecture where multiple concurrent users utilize the same development applications installed on the application platform 365. Also, by utilizing the multi-tenant architecture in conjunction with the application platform 365 integration with web services and databases via common standards and communication tools can be configured. As an example, SALESFORCE SERVICECLOUD® is an application platform residing on the server 360 that hosts the server on-line survey app 351 and may host all the varying services needed to fulfil the application development process of the server on-line survey app 351. The SALESFORCE SERVICECLOUD® as an example, may provide web based user interface creation tools to help to create, modify, test and deploy different UI scenarios of the server on-line survey app 351.

The application platform 365 includes applications relating to the server on-line survey app 351. The server on-line survey app 351 is an application that is part of a platform that communications with the mobile client 345, more specifically provides linking for data communications to the mobile client 345 for multimedia data capture and streaming to the server 360. The server on-line survey app 351 may include other applications in communication and data discovery, data prediction, pre-filling of response data and means for accessing a multi-tenant database 355 as an example, in a multi-tenant database system. In addition, the server on-line survey app 351 may include components configurable to include user-interfaces (UI) to display a webpage created or potentially alternative webpage configurations for selection and viewing as well as linking with AI engines of the feature module 352 for displaying of pre-filled response and predictive data. In an exemplary embodiment, the display of the webpage may present Uls for displaying the survey results.

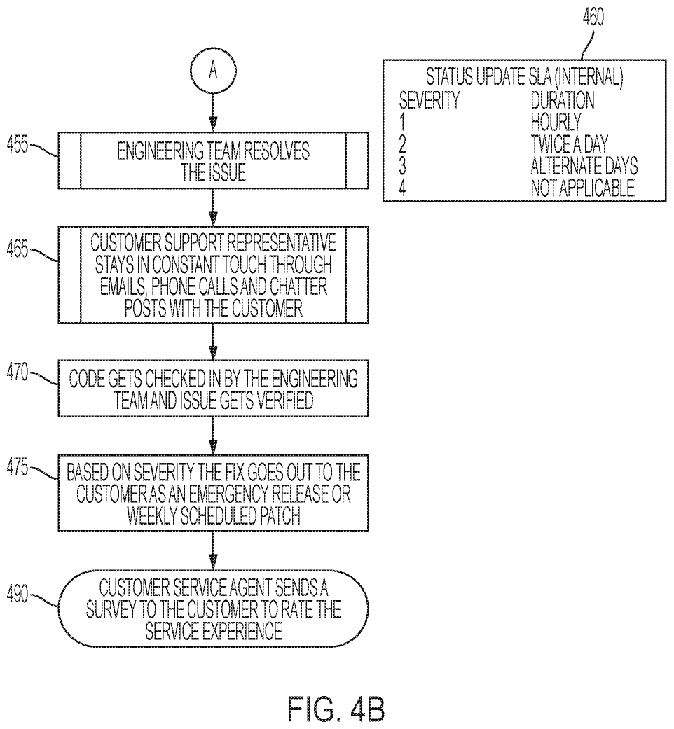

FIGS. 4A and 4B are flow charts that illustrate an embodiment of a process for initiating a case investigation, acknowledging the case, and checking of additional information for an on-line survey system with pre-filled and predictive response data, in accordance with the disclosed embodiments. In FIG. 4A, a flowchart describes a customer initiated request process with various data points for collection by an on-line targeted survey to an end user in accordance with an embodiment.

The customer at task 410, initiates a case or investigation. Once initiated, in accordance with a service agreement with the service vendor, at task 420 a customer service representative acknowledges the case base on a priority in receipt of as defined per the service agreement with the service vendor. In various exemplary embodiments, the severity level of the targeted initial response time to customer can be quantified in one business hour, two business hours, three business hours, four business hours, and eight business hour periods shown in block 425. At task 430, the customer service representative checks the description and if additional information is needed request that the additional information from the customer. At task 440, the engineering or IT support team vendor acknowledgements the case. In various instances, this may be limited to a notification or may include further investigatory tasks. In any event, at task in block 445 along with the acknowledgement, the engineering team or IT support vendor may assign a severity level in accordance with pre-defined priority severity level scheme. As shown in block 445, a particular severity level can be characterized by an acknowledgement time. For example, a lesser acknowledgement time would infer a higher severity level requiring a more immediate action. While a longer acknowledgement time would likewise implicitly mean that the severity level is less. In Block 445 severity levels with corresponding acknowledgment times of seven minutes, four hours, eight hours and “not applicable” times are displayed. Next, at 450, the engineering or IT support team may check if additional information is needed. If additional information is required, an affirmative “yes” and the flow proceeds back to task 420 to repeat the tasks 420, 430 and 440 to re-acknowledge the case based on the priority, to check descriptions of the request and ask for additional information and re-assign an engineering team or IT support team acknowledgement with a severity level. The process flow is dynamic and allows for a continuous re-assessment of the customer request; for example contemplating a scenario, what may appear to be a localized request may have dynamic qualities and propagate through the network and therefore no longer be localized. In this case, the severity level should or must be changed in accordance with magnitude, severity, or urgency of the request as the request has a significantly larger impact than was initially the case. The feedback process can reassess the acknowledgment of priority at task 420 and ask for the additional information at task 430 to enable a different severity level of block 445 to be assigned at task 440 by the engineering or IT support team.

With continuing reference to FIGS. 4A and 4B, FIG. 4B is a flow chart that illustrates an embodiment of further process steps for initiating a case investigation, acknowledging the case, and checking of additional information for an on-line survey system with pre-filled and predictive response data, in accordance with the disclosed embodiments. At task 455, after ensuring all additional information requests are fulfilled, the engineering team or IT support team resolves the issue and may also issue a status update. The status update are issued as described in block 450; block 450 describes the status update to an service level agreement (SLA) with a severity and duration of “1”, “2”, “3” and “4” corresponding to durations of hourly, “twice a day”, “alternate days”, and “not applicable”. At 465, the customer support representative stays in constant touch through email, phone calls and chatter posts via the networking platform with the customer. In various exemplary embodiments, the SALESFORCE EINSTEIN™ application can be integrated or communicated with to provide such advanced artificial intelligence features such as sentiment analysis with such posts, emails, and related conversations. In addition, the SALESFORCE EINSTEIN™ has sales analytics tools that may be used here as well as discovery tools to provide such features as trend monitoring of the feedback intake. At task 470, the code related to the request is checked in (i.e. in a blockchain ledger or other docketing tool) by the engineering or IT teams for further verification of the issue related to the customer request. At 475, based on an assessment of the severity, the fix is sent out to the customer as either an emergency fix release or a regularly scheduled update such as a weekly update or scheduled patch fix. At task 490, the vendor (i.e. customer service agent) sends a survey to the end user or customer to evaluate and rate the service experience just completed.

In various embodiments, a service cloud case closure would entail after a customer has closed his or her case, the following data points would provide basis for fill in responses and prediction analytics in an on-line survey and are as follows: 1. The initial expected time amount (ETA) for the first acknowledgment within SLAs based on Severity of the issue. 2. Whether the overall time taken to resolve the issue was in-line with expectations based on severity of the issue. 3. Any timely updates sent to the customer which are dependent on the Severity of the issue. 4. Any number of back and forth questions between the customer and the vendor to get more information about the issue request and log the request by the engineering or IT support team. 5. Any reopening of the case before the final closure of the request. 6. Any sentiment assessment by the artificial engine analytics on feed comments provided by the customer in each step of the process flow.

The pre-population of the responses in the on-line survey can be based on machine language engine trained or configured based on the above process steps. The user is given an opportunity to change the prepopulated survey responses to enable proper accuracy of the collected data responses and to inform the on-line system of further objections with any of the automated fill-in responses or artificial intelligence predicted responses. This additional feedback by the user and a recursive training loop for tuning implicit and explicit responses provides for more accuracy of the response model with a particular user response data set and the feature data used to ensure higher accuracies in the substance of the responses or predicted data in the eventual on-line response data set.

In various embodiments, in a case closure feedback response in the service cloud session, a survey is sent out to a customer (i.e. the targeted customer) after the case closure or the customer issue has been resolved. The predicted or response data that is filled in can be conjured using applications solutions from the artificial engine analytics engines based on data points related to the initial ETA for a first acknowledgment to a customer request, whether the overall time taken to resolve the issue was in line with our service agreements, number of back and forth questions that happened, Any reopens before the ultimate closure and Based on the above data to prepopulate the survey responses which can be re-configured manually by the user. If none of the assumptions are instituted, then the pre-population would only be based on the rule engine and any intelligent analytics used.

In an exemplary embodiment, a survey is sent to a customer of a ride sharing or like application after the customer has used the particular service. Typically, such services have instrumented processes that only enable a customer to request another service if a targeted on-line survey sent has been completed. This results in customers providing “dummy” survey responses without meaningful data. On the other hand, if the targeted on-line survey is sent and pre-populated at the same time with response data, there is a greater likelihood that the customers would give more meaningful responses as such responses would then require only “agreeing” to already filled in responses; requiring less thought and less customer selection of response data. This is particularly the case went the service received is not out of the norm and the response data is likely easy to anticipate. Alternately, when the response data is not the norm, the service is not as normally expected; in such instances, pre-populating the survey with predicted data would likely result in erroneous filled-in response supporting positive results for the service if the related data points are not taken into account. That is, some of the data points can be used to predict the type of response results expected; in this case, a service not in the norm. These data points may include: 1. a ride share service search time 2. availabilities of vehicles for use to the ride-share customer request 3. a promptness of a response by the driver to the customer request and 4. a time taken for a ride with the customer based on distance and/or route taken by the driver.

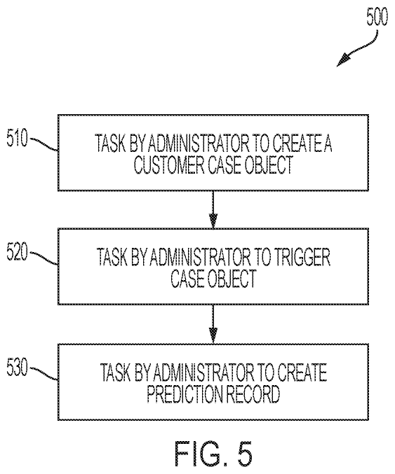

FIG. 5 is a flowchart illustrating an administrative set-up for the on-line survey system in accordance with the disclosed embodiments.

In various exemplary embodiments, the SALESFORCE® Platform can be configured with SALESFORCE® EINSTEIN™ application which is a layer of artificial intelligence that delivers predictions based on customer enterprise processes and customer data. For example, the SALESFORCE® EINSTEIN™ Prediction Builder (EBP) engine can be used for predicting the survey responses. The EBP is a custom AI engine that users (ex. administrative users) can configure as desired or needed to predict results based on training data. The EBP requires in advance defining of the input fields received at input and data types for proper comprehension and analysis of the field data. The EBP can be configured to predict a number of types of fields such as a checkbox, a specially constructed formula field and a numeric field data. The EPB is implemented to predict Customer Satisfaction (CSAT) scores. The CSAT score is a straightforward of the customer satisfaction survey methodologies, and the CSAT score measures customer satisfaction with a business, purchase, or interaction. For example, “How satisfied were you with your experience?”.

Referring to FIG. 5, of an administrator set-up or configuration. In various embodiments, the administrative set-up may be implemented by a SALEFORCE® administrator. In the administrative set-up 500, initially, step (1), at task 510, the administrator creates a custom field on Case object called CSAT Predicted of type number. Next, at 520, the user or administrator configures, step (2), a trigger on the case object. The Case object trigger may be configured as a response to a number of case related actions. The case object trigger can (a) create and send a Survey Invitation whenever the Case status changes to Closed, and (b) when an action occurs of associating the Survey invite to the particular case. Next, at 530, the user of administrator, step (3), creates a new prediction record (EBP). To create the new prediction record (ex. a new prediction record of the SALESFORCE® EINSTEIN™ Prediction Builder (EBP)), the user or administrator performs the following steps: (a) the user or administrator selects the list of columns from the Case to use for the prediction. In an example, a list of columns may be configured as: Start Date, End Date, Case Age, Severity Level, Support Level, Customer Age, Is Escalated, Escalation Reason, Date Escalated, service level agreement (SLA) information Initial Response, SLA Information Resolution, Follow-up Violation Count and CSAT Actual (i.e. from a surveys object). The, the user or administrator, selects the target field desired to be predicted. That is, at step (b), the user or administrator select the target field as the CSAT Predicted custom field on the Case object.

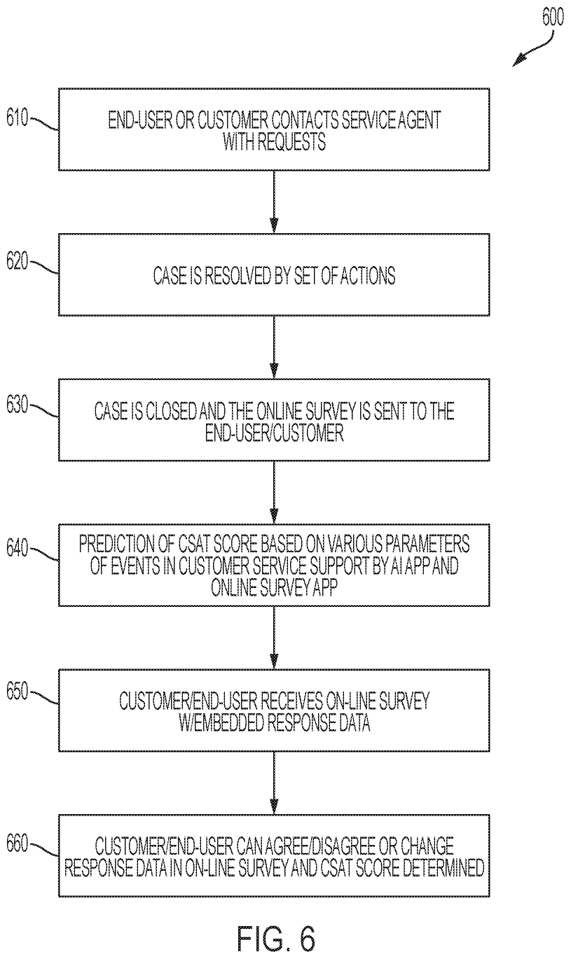

FIG. 6 is a flowchart illustrating a run-time of the on-line survey system in accordance with the disclosed embodiments. The process flow 600 of the runtime, enables the customer to contact the service agent with requests related to the Case, resolve such requests, and upon closure of the Case, have a survey sent out to solicit customer feedback of the user experience. Initially, at task 610, step (1), the customer or end user contacts the service agent (ex. a SALESFORCE® administrator or designated help-support personnel) with an issues and the Case created by the service agent. At task 620, step (2), the case is processed, and is resolved at some point. This processing on or working on may involve a number of back and forth communications with the end user as well as internal communication between a company personnel, support department to resolve the issue.

At some point, at task 630, step (3), the case is closed, is deemed to be closed and a survey is automatically sent out to the end user to determine a CSAT score for the service experience by the end user (i.e. the customer) in the service to characterize factors such as the quality of service, expediency of the service, interactions with a customer service representative, eventual technical resolution, particularities of the fix etc. At task 640, step (4) the EBP predicts the CSAT predicted score based on the parameters defined (i.e. times, start stop, etc.) and populate each prediction of a customer or end user response of the appropriate type required by the field definition of the custom field. At task 650, step (5), the end user will either attempt to put in his or her own responses and fill in the survey. If the response required is unfilled, the an application of the on-line survey system app pre-populate the CSAT score with a predicted value, or can suggest a predicted value to the end user when the end user is filling out the survey. At task 660, step (6), the end user can choose to either keep or retains the prediction value which has been pre-filled or can changes the predicted value based on his or her own personal evaluation of the case resolution and then after completion can submits the survey or even not complete the survey and submit. By the end user agree to the predicted values pre-filled or not agreeing to the predicted values, the overall accuracy of the pre-filled values is increased as a database storing the pre-filled predicted values can be updated. Moreover, if an end user changes a value that is out of the norm, this out of the norm value can be detected and either changed to the predicted value in the norm or the end user given another opportunity to review his or her response with the appropriate alert. The CSAT which is determined by the end user is the actual CSAT score and this can be saved in the survey object.

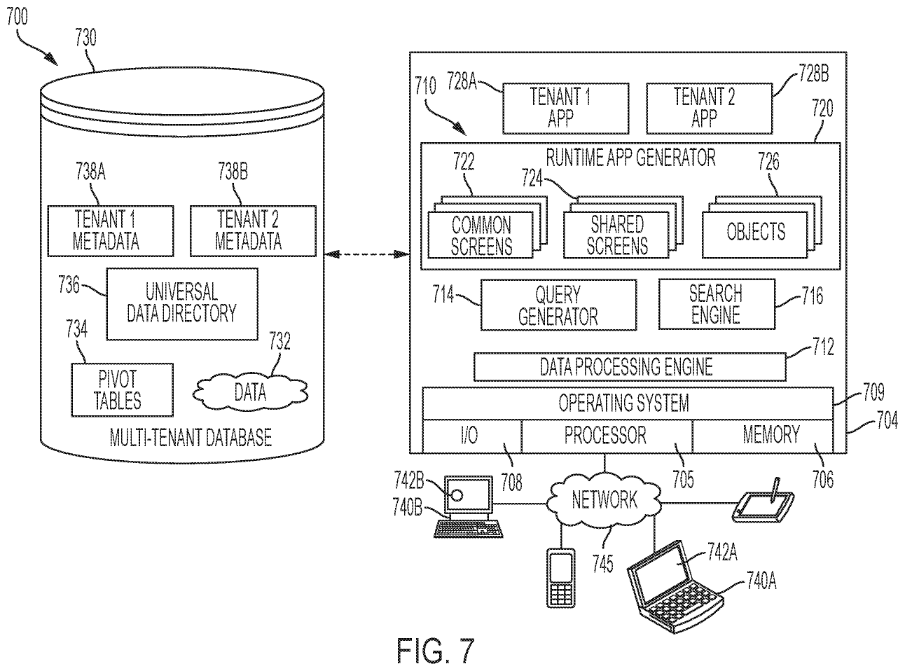

FIG. 7 is a conceptual block diagram of a multi-tenant system 700 in accordance with the disclosed embodiments. The multi-tenant system 700 may be used to in conjunction with the CRM software applications described previously. Platform as a Service (PaaS) is the foundation of the multi-tenant architecture. At the heart, this PaaS is a relational database management system. All of the core mechanisms in a relational database management system (RDBMS) (e.g., a system catalog, caching mechanisms, query optimizer, and application development features) are built to support multi-tenant applications and to be run directly on top of a specifically tuned host operating system and raw hardware. The runtime engine has the intelligence to access the metadata and transactional data and perform the application functionality that can scale.

The multi-tenant system 700 of FIG. 7 includes a server 702 that dynamically creates and supports virtual applications 728 based upon data 732 from a common database 730 that is shared between multiple tenants, alternatively referred to herein as a multi-tenant database. Data and services generated by the virtual applications 728 are provided via a network 745 to any number of client devices 740, as desired. Each virtual application 728 is suitably generated at run-time (or on-demand) using a common application platform 710 that securely provides access to the data 732 in the database 730 for each of the various tenants subscribing to the multi-tenant system 700. In accordance with one non-limiting example, the multi-tenant system 700 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 730. In this regard, each tenant includes one or more users associated with, assigned to, or otherwise belonging to that respective tenant. To put it another way, each respective user within the multi-tenant system 700 is associated with, assigned to, or otherwise belongs to a particular tenant of the plurality of tenants supported by the multi-tenant system 700. Tenants may represent customers, customer departments, business or legal organizations, and/or any other entities that maintain data for particular sets of users within the multi-tenant system 700 (i.e., in the multi-tenant database 730). For example, the application server 702 may be associated with one or more tenants supported by the multi-tenant system 700. Although multiple tenants may share access to the server 702 and the database 730, the particular data and services provided from the server 702 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 732 belonging to or otherwise associated with other tenants.

The multi-tenant database 730 is any sort of repository or other data storage system capable of storing and managing the data 732 associated with any number of tenants. The database 730 may be implemented using any type of conventional database server hardware. In various embodiments, the database 730 shares conventional processing hardware 704 with the server 702. In other embodiments, the database 730 is implemented using separate physical and/or virtual database server hardware that communicates with the server 702 to perform the various functions described herein. In an exemplary embodiment, the database 730 includes a database management system or other equivalent software capable of determining an optimal query plan for retrieving and providing a particular subset of the data 732 to an instance of virtual application 728 in response to a query initiated or otherwise provided by a virtual application 728. The multi-tenant database 730 may alternatively be referred to herein as an on-demand database, in that the multi-tenant database 730 provides (or is available to provide) data at run-time to on-demand virtual applications 728 generated by the application platform 710.

In practice, the data 732 may be organized and formatted in any manner to support the application platform 710. In various embodiments, the data 732 is suitably organized into a relatively small number of large data tables to maintain a semi-amorphous “heap”-type format. The data 732 can then be organized as needed for a particular virtual application 728. In various embodiments, conventional data relationships are established using any number of pivot tables 734 that establish indexing, uniqueness, relationships between entities, and/or other aspects of conventional database organization as desired. Further data manipulation and report formatting is generally performed at run-time using a variety of metadata constructs. Metadata within a universal data directory (UDD) 736, for example, can be used to describe any number of forms, reports, workflows, user access privileges, business logic and other constructs that are common to multiple tenants. Tenant-specific formatting, functions and other constructs may be maintained as tenant-specific metadata 738 for each tenant, as desired. Rather than forcing the data 732 into an inflexible global structure that is common to all tenants and applications, the database 730 is organized to be relatively amorphous, with the pivot tables 734 and the metadata 738 providing additional structure on an as-needed basis. To that end, the application platform 710 suitably uses the pivot tables 734 and/or the metadata 738 to generate “virtual” components of the virtual applications 728 to logically obtain, process, and present the relatively amorphous data 732 from the database 730.

The server 702 is implemented using one or more actual and/or virtual computing systems that collectively provide the dynamic application platform 710 for generating the virtual applications 728. For example, the server 702 may be implemented using a cluster of actual and/or virtual servers operating in conjunction with each other, typically in association with conventional network communications, cluster management, load balancing and other features as appropriate. The server 702 operates with any sort of conventional processing hardware 704, such as a processor 705, memory 706, input/output features 708 and the like. The input/output features 708 generally represent the interface(s) to networks (e.g., to the network 745, or any other local area, wide area or other network), mass storage, display devices, data entry devices and/or the like. The processor 705 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 706 represents any non-transitory short or long term storage or other computer-readable media capable of storing programming instructions for execution on the processor 705, including any sort of random access memory (RAM), read only memory (ROM), flash memory, magnetic or optical mass storage, and/or the like. The computer-executable programming instructions, when read and executed by the server 702 and/or processor 705, cause the server 702 and/or processor 705 to create, generate, or otherwise facilitate the application platform 710 and/or virtual applications 728 and perform one or more additional tasks, operations, functions, and/or processes described herein. It should be noted that the memory 706 represents one suitable implementation of such computer-readable media, and alternatively or additionally, the server 702 could receive and cooperate with external computer-readable media that is realized as a portable or mobile component or application platform, e.g., a portable hard drive, a USB flash drive, an optical disc, or the like.

The application platform 710 is any sort of software application or other data processing engine that generates the virtual applications 728 that provide data and/or services to the client devices 740. In a typical embodiment, the application platform 710 gains access to processing resources, communications interfaces and other features of the conventional processing hardware 704 using any sort of conventional or proprietary operating system for processor 705. The virtual applications 728 are typically generated at run-time in response to input received from the client devices 740. For the illustrated embodiment, the application platform 710 includes a bulk data processing engine 712, a query generator 714, a search engine 716 that provides text indexing and other search functionality, and a runtime application generator 720. Each of these features may be implemented as a separate process or other module, and many equivalent embodiments could include different and/or additional features, components or other modules as desired.

The runtime application generator 720 dynamically builds and executes the virtual applications 728 in response to specific requests received from the client devices 740. The virtual applications 728 are typically constructed in accordance with the tenant-specific metadata 738, which describes the particular tables, reports, interfaces and/or other features of the particular application 728. In various embodiments, each virtual application 728 generates dynamic web content that can be served to a browser or other client program 742 associated with its client device 740, as appropriate.

The runtime application generator 720 suitably interacts with the query generator 714 to efficiently obtain multi-tenant data 732 from the database 730 as needed in response to input queries initiated or otherwise provided by users of the client devices 740. In a typical embodiment, the query generator 714 considers the identity of the user requesting a particular function (along with the user's associated tenant), and then builds and executes queries to the database 730 using system-wide metadata 736, tenant specific metadata 738, pivot tables 734, and/or any other available resources. The query generator 714 in this example therefore maintains security of the common database 730 by ensuring that queries are consistent with access privileges granted to the user and/or tenant that initiated the request. In this manner, the query generator 714 suitably obtains requested subsets of data 732 accessible to a user and/or tenant from the database 730 as needed to populate the tables, reports or other features of the particular virtual application 728 for that user and/or tenant.

Still referring to FIG. 7, the data processing engine 712 performs bulk processing operations on the data 732 such as uploads or downloads, updates, on-line transaction processing, and/or the like. In many embodiments, less urgent bulk processing of the data 732 can be scheduled to occur as processing resources become available, thereby giving priority to more urgent data processing by the query generator 714, the search engine 716, the virtual applications 728, etc.

In exemplary embodiments, the application platform 710 is utilized to create and/or generate data-driven virtual applications 728 for the tenants that they support. Such virtual applications 728 may make use of interface features such as custom (or tenant-specific) screens 724, standard (or universal) screens 722 or the like. Any number of custom and/or standard objects 726 may also be available for integration into tenant-developed virtual applications 728. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 726 such as “account” objects, “opportunity” objects, “contact” objects, or the like. The data 732 associated with each virtual application 728 is provided to the database 730, as appropriate, and stored until it is requested or is otherwise needed, along with the metadata 738 that describes the particular features (e.g., reports, tables, functions, objects, fields, formulas, code, etc.) of that particular virtual application 728. For example, a virtual application 728 may include a number of objects 726 accessible to a tenant, wherein for each object 726 accessible to the tenant, information pertaining to its object type along with values for various fields associated with that respective object type are maintained as metadata 738 in the database 730. In this regard, the object type defines the structure (e.g., the formatting, functions and other constructs) of each respective object 726 and the various fields associated therewith.

Still referring to FIG. 7, the data and services provided by the server 702 can be retrieved using any sort of personal computer, mobile telephone, tablet or other network-enabled client device 740 on the network 745. In an exemplary embodiment, the client device 740 includes a display device, such as a monitor, screen, or another conventional electronic display capable of graphically presenting data and/or information retrieved from the multi-tenant database 730. Typically, the user operates a conventional browser application or other client program 742 executed by the client device 740 to contact the server 702 via the network 745 using a networking protocol, such as the hypertext transport protocol (HTTP) or the like. The user typically authenticates his or her identity to the server 702 to obtain a session identifier (“SessionID”) that identifies the user in subsequent communications with the server 702. When the identified user requests access to a virtual application 728, the runtime application generator 720 suitably creates the application at run time based upon the metadata 738, as appropriate. As noted above, the virtual application 728 may contain Java, ActiveX, or other content that can be presented using conventional client software running on the client device 740; other embodiments may simply provide dynamic web or other content that can be presented and viewed by the user, as desired.

The various tasks performed in connection with processes may be performed by software, hardware, firmware, or any combination thereof. For illustrative purposes, the preceding descriptions of processes may refer to elements mentioned above in connection with FIGS. 1-7. In practice, portions of processes may be performed by different elements of the described system, e.g., on-line prediction survey system with prediction artificial intelligence (AI) modeling applications. It should be appreciated that processes may include any number of additional or alternative tasks, the tasks shown in FIGS. 1-7 need not be performed in the illustrated order, and processes may be incorporated into a more comprehensive procedure or process having additional functionality not described in detail herein. Moreover, one or more of the tasks shown in FIGS. 1-7 could be omitted from embodiments of the processes as long as the intended overall functionality remains intact.

In various exemplary embodiments, the present disclosure describes methods and systems with FIGS. 1-7 for embedding response data to an on-line survey when soliciting feedback through the use of an on-line survey to user about an user experience to a software application service provided, including: receiving an acknowledgement that the software application service is completed by the user, prior to sending to the user the on-line survey for completion; sending the on-line survey with response data included to aid the user in completing the on-line survey wherein the user is an electronically targeted user of the on-line survey by virtue of an use by the user of the software application service; embedding with response data pre-filled or predicted responses to at least one or more questions in the on-line survey by using an artificial intelligence (AI) model based on historical response data to on-line surveys and the response data predicted either directly or indirectly by algorithmic solutions from a set of data points and machine data designated within the software application service wherein the set of data points at least comprise data of time periods corresponding to: response time of providers to user requests, response time of providers to update data of the user requests; and response time of providers to resolve the user requests during the software application service; and enabling the user to selectively agree or disagree with embedded pre-filled or predicted response data included in the on-line survey prior to and during a completing of the on-line survey to ensure a sufficient level of accuracy in results of the response data collected by the on-line survey of the software application service.

In various exemplary embodiments, the present disclosure describes methods and systems with FIGS. 1-7 for a computer program product tangibly embodied in a computer-readable storage device and comprising instructions that when executed by a processor perform a method for predicting response data in an on-line survey sent to a customer to solicit feed-back of a customer experience provided by a support service in an enterprise network for resolving a customer request between a service agent and the customer by performing one or more actions, by the processor, on the enterprise network between the customer, an app of the enterprise network and the service agent; configuring the one or more actions into one or more event of the support service associated with the customer request; sending an on-line survey to the customer after resolving the customer request by an on-line survey app to solicit response data about the customer experience wherein the on-line survey app generates the on-line survey; defining a set of fields for the response data in the on-line survey to configure a set of inputs for the on-line survey app wherein the set of inputs at least comprises: a checkbox, a formula field and a numeric field data; and pre-filling the response data by response data generated by an artificial intelligence (AI) app coupled to the on-line survey app for predicting the response data using a prediction solution application wherein the prediction data is based at least on a set of time periods of data points and historical response data of a set of events in the support service.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The preceding description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. 1-7 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for embedding response data to an on-line survey when soliciting feedback through the use of an on-line survey to user about an user experience to a software application service provided, the method comprising:
receiving an acknowledgement that the software application service is completed by the user, prior to sending to the user the on-line survey for completion;
sending the on-line survey with response data included to aid the user in completing the on-line survey wherein the user is an electronically targeted user of the on-line survey by virtue of an use by the user of the software application service;
embedding with response data pre-filled or predicted responses to at least one or more questions in the on-line survey by using an artificial intelligence (AI) model based on historical response data to on-line surveys and the response data predicted either directly or indirectly by algorithmic solutions from a set of data points and machine data designated within the software application service wherein the set of data points at least comprise data of time periods corresponding to: response time of providers to user requests, response time of providers to update data of the user requests; and response time of providers to resolve the user requests during the software application service; and
enabling the user to selectively agree or disagree with embedded pre-filled or predicted response data included in the on-line survey prior to and during a completing of the on-line survey to ensure a sufficient level of accuracy in results of the response data collected by the on-line survey of the software application service.

2. The method of claim 1, further comprising augmenting response data in the AI model, by:
processing a set of event data using the AI model wherein the set of event data comprises identifying factors related to data points correlated to positive response data of users of the software application service.

3. The method of claim 1, further comprising:
computing a predicted time duration for each response using the AI model based on the historical response data.

4. The method of claim 3, further comprising:
associating index values of severity levels, acknowledge times, and updates to the response data.

5. The method of claim 1, further comprising monitoring the index value, by:
updating the index value by performing one or more additional index value calculations using the AI model and the historical response data.

6. The method of claim 4, further comprises:
scheduling software patches to resolve the user requests based on an index values of severity levels.

7. The method of claim 1, further comprises:
configuring embedding response data within the on-line surveys by measuring increases in an user response rate.

8. A computer program product tangibly embodied in a computer-readable storage device and comprising instructions that when executed by a processor perform a method for predicting response data in an on-line survey sent to a customer to solicit feed-back of a customer experience provided by a support service in an enterprise network, the method comprising:
resolving a customer request between a service agent and the customer by performing one or more actions, by the processor, on the enterprise network between the customer, an app of the enterprise network and the service agent;
configuring the one or more actions into one or more event of the support service associated with the customer request;
sending an on-line survey to the customer after resolving the customer request by an on-line survey app to solicit response data about the customer experience wherein the on-line survey app generates the on-line survey;
defining a set of fields for the response data in the on-line survey to configure a set of inputs for the on-line survey app wherein the set of inputs at least comprises: a checkbox, a formula field and a numeric field data; and
pre-filling the response data by response data generated by an artificial intelligence (AI) app coupled to the on-line survey app for predicting the response data using a prediction solution application wherein the prediction data is based at least on a set of time periods of data points and historical response data of a set of events in the support service.

9. The computer program product of claim 8, comprising instructions for the processor to perform the method for processing the customer request further comprising:
enabling the customer to selectively agree or disagree with pre-filled predicted response data in the on-line survey prior to and during a completing of the on-line survey to ensure a sufficient level of accuracy in results of the response data collected by the on-line survey.

10. The computer program product of claim 9, comprising instructions for the processor to perform the method for processing the customer request further comprising:
checking a value of a predicted response to the value of the response data by the customer to ensure the value is with a normal value range for accuracy of the response data collected.

11. The computer program product of claim 9, comprising instructions for the processor to perform the method for processing the customer request further comprising:
receiving an acknowledgement that the support service is completed by the customer, prior to sending to the customer the on-line survey for filling out response data.

12. The computer program product of claim 9, comprising instructions for the processor to perform the method for processing the customer request further comprising:
filling response data which is un-filled on the part of the customer when completing the on-line survey.

13. The computer program product of claim 9, comprising instructions for the processor to perform the method for processing the customer request further comprising:
calculating a customer satisfaction (CSAT) score for the customer with a predicted value for the customer based on the predicted response data.

14. The computer program product of claim 13, comprising instructions for the processor to perform the method for processing the customer request further comprising:
suggesting a predicted value of the customer satisfaction score to the customer while the customer is filling out response data in the on-line survey.

15. The computer program product of claim 9, comprising instructions for the processor to perform the method for processing the customer request further comprising:
computing a predicted time duration for each response by the customer in the on-line survey based on a set of historical response data.

16. The computer program product of claim 15, comprising instructions for the processor to perform the method for processing the customer request further comprising:
associating index values of severity levels, acknowledge times, and updates to the predicted response data.

17. A system comprising:
at least one processor; and
at least one computer-readable storage device comprising instructions that when executed causes performance of a method for processing requests in an enterprise app session between a service agent and a customer, the method comprising:
resolving a customer request between the service agent and the customer for a customer service app by performing one or more actions, by the processor, on an enterprise network between a set comprising: the customer, an app of the enterprise network and the service agent;
configuring the one or more actions into one or more event of customer support service associated with the customer request;
sending an on-line survey to the customer after resolving the customer request by an on-line survey app to solicit response data about customer satisfaction wherein the on-line survey app generates the on-line survey;
defining a set of fields for response data in the on-line survey to configure a set of inputs for the on-line survey app wherein the set of inputs at least comprises: a checkbox, a formula field and a numeric field data;
pre-filling the response data by response data generated by an artificial intelligence (AI) app coupled to the on-line survey app for predicting the response data using a prediction solution application wherein the prediction data is based at least on a set of time periods of data points and historical response data of the events in the customer service app; and
enabling the customer to selectively agree or disagree with pre-filled predicted response data in the on-line survey prior to and during a completing of the on-line survey to ensure a sufficient level of accuracy in results of the response data collected by the on-line survey.

18. The system of claim 17, further comprising:
calculating a customer satisfaction (CSAT) score for the customer with a predicted value for the customer based on the predicted response data.

19. The system of claim 18, further comprising:
suggesting a predicted value of the customer satisfaction score to the customer while the customer is filling out response data in the on-line survey.

20. The system of claim 18, further comprising:
associating index values of severity levels, acknowledge times, and updates to the predicted response data.
